(19) United States
(12) Patent Application Publication
(10) Pub. No.: US 2007/0084046 A1
(43) Pub. Date: Apr. 19, 2007

(54) Method of Repairing Helical Cable Sheathing

(76) Inventor: Allan Stikeleather, Canton, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/551,006

(22) Filed: Oct. 19, 2006

Related U.S. Application Data
(60) Provisional application No. 60/728,229, filed on Oct. 19, 2005.

(51) Int. Cl. H01R 4/00

(52) U.S. Cl. 29/868; 174/84 R; 174/92; 29/825; 29/828

(57) ABSTRACT

A method of joining two pieces of helically wound armored cable sheathing, including trimming adjacent ends of the two pieces of armored cable sheathing to provide complimentary interlocking features. The two pieces of armored cable sheathing are threadably coupled by engaging the complimentary interlocking features and twisting the two pieces of armored cable sheathing. An electrically conductive member is placed in electrical contact with both of the pieces of armored cable sheathing, and a protective covering is applied over the joint between the two pieces of armored cable sheathing to mechanically coupled the pieces of armored cable sheathing to prevent the untwisting of the pieces.

### CROSS-REFERENCE TO RELATED APPLICATIONS

This application claims the benefit of U.S. Provisional patent application Ser. No. 60/728,229, filed Oct. 19, 2005, the entire disclosure of which is hereby incorporated herein by reference.

### FIELD

The present disclosure generally relates to flexible metallic sheathing for wiring, and more particularly relates to the repair of helical metallic cable sheathing

### BACKGROUND

Armored cable, including a flexible metallic sheathing covering several electrical conductors, may be permitted by the electrical code in many locations and for many types of construction. Typically, armored cable is produced by forming a metallic strip into an interlocking geometry and wrapping it around one or more conductors to be protected. The manufacturing process for armored cable may place a great deal of stress on the metallic strip. Incorrect processing parameters or defects in the metal strip may result in a breakage of the armored cable sheath before a desired length has been produced. Because armored cable is typically sold in standard commercial lengths, any sections of armored cable less than the standard commercial length is considered waste. Waste pieces of armored cable are generally cut from the manufacturing line, resulting in a great deal of lost material, time and manufacturing resources.

### BRIEF DESCRIPTION OF THE DRAWINGS

Features and advantages of the present invention will be apparent from the following description of embodiments consistent therewith, which description should be considered in conjunction with the accompanying drawings, wherein:

FIG. 1 is a cross-sectional view schematically showing an interlocking profile of an armored cable;

FIG. 2 schematically depicts two pieces of armored cable to be spliced;

FIG. 3 schematically depicts two pieces of armored cable with the ends prepared for mechanically coupling the pieces together consistent with an embodiment of the present disclosure;

FIG. 4 schematically depicts two pieces of armored cable threadably coupled together consistent with the present disclosure;

FIG. 5 depicts two pieces of armored cable joined together and including a separate conductive member bridging the joint consistent with an embodiment of the present disclosure; and

FIG. 6 shows an embodiment of a spliced armored cable consistent with the present disclosure.

### DESCRIPTION

Consistent with the present disclosure, separate pieces of helically wound, interlocked metallic cable sheathing, i.e., armored cable sheathing, may be joined and/or spliced together to form a generally continuous sheath. According to one aspect, the method herein may be employed during the manufacture of armored cable including one or more electrical conductors disposed within the armored cable sheathing. Pieces of armored cable sheathing may be joined and/or spliced to one another, for example, to extend the length of a continuous unit of armored cable. For example, the method herein may be used to extend the length of a unit of armored cable in the event of a breakage of the metallic strip during manufacturing of the armored cable, etc.

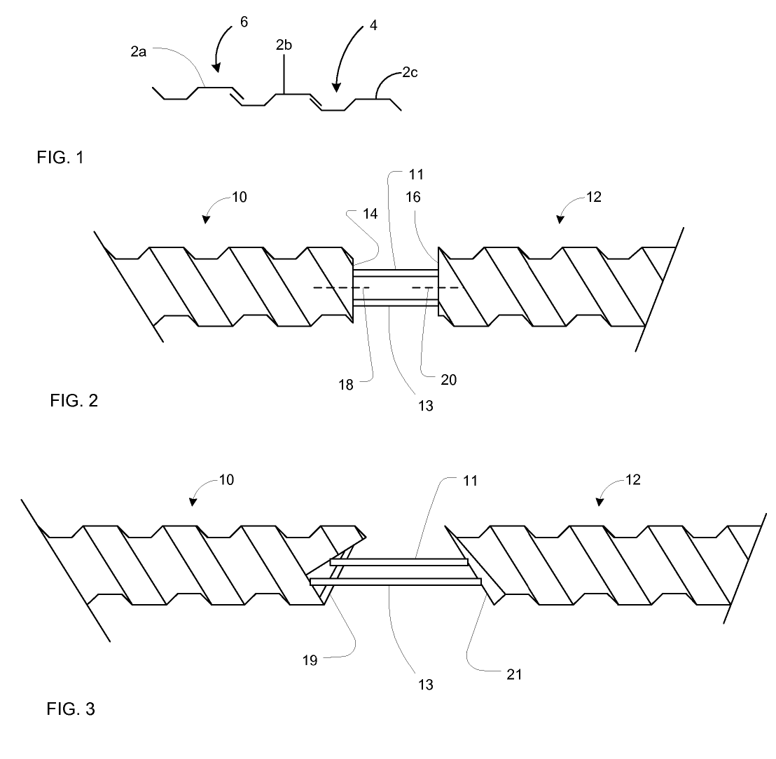

Generally, the armored cable may include one or more electrical conductors extending through the flexible metallic sheathing. The armored cable sheathing may be manufactured by helically winding a strip of metal, such as steel, aluminum, etc. As the metallic strip is helically wound, e.g., around the one or more conductors, the strip may be formed such that adjacent turns 2a, 2b, 2c of the metallic strip form interlocking features, such as shown in FIG. 1. The shape of the adjacent turns 2a, 2b, 2c of the metallic strip shown in FIG. 1 is only one of numerous variations which may provide interlocking of adjacent and/or partially overlapping portions of the strip, and should not be construed as limiting the invention. As shown, in FIG. 1, when the strip is helically wound to engage the interlocking features of adjacent and/or partially overlapping portions, the resulting sheath may include a series of helical grooves 4 and ridges 6.

In the context of a breakage during the manufacture of armored cable, when a breakage of the metal strip occurs, a new, or second, length of armored cable sheathing may be started over the conductors disposed in the first piece of armored cable sheathing. The new, or second piece, of armored cable sheathing may begin adjacent to the end of the first piece of armored cable sheathing. Initially, there may be a gap between the first and second pieces of armored cable sheathing 10, 12. After at least a short length of the second piece 12 of armored cable sheathing has been formed, the first and second pieces of armored cable sheathing may be joined and/or spliced together.

Referring to FIG. 2, two pieces of armored cable sheathing 10, 12 are shown disposed over conductors 11, 13. A greater of fewer number of conductors may be disposed within the armored cable sheathing. Additionally, other features such as a Mylar wrap, etc. may also be disposed within the armored cable sheathing. Such additional features have been omitted from the drawings for the sake of clarity. As shown, with the two pieces of armored cable sheathing 10, 12 positioned adjacent to one another, the respective ends 14, 16 of the pieces of armored cable sheathing 10, 12 may be trimmed so that they are generally complimentary. For example, as shown, the ends 14, 16 of the two pieces of armored cable sheathing 10, 12 may be trimmed so that they can be threaded together. For example, the pieces of armored cable sheathing 10, 12 may be trimmed so that they are generally squared off, e.g., to provide a perpendicular face relative to the length of the respective pieces of armored cable sheathing 10, 12. The trimmed ends 14, 16 may be configured to generally butt together. According to one embodiment, the trimmed ends 14, 16 of the pieces of armored cable sheathing 10, 12 may create a tight fit relative to one another. However, according to various alternative embodiments, it is not necessary for the trimmed ends 14, 16 of the pieces of armored cable sheathing 10, 12 to provide a tight fit to one another. According to one embodiment, the ends 14, 16 of the pieces of armored cable sheathing 10, 12 may be trimmed using a commercially available tool used for cutting armored cable. An example of such a tool is a FLEX SPLITTER 1940, available from Greenlee Textron. Various additional and/or alternative tools and/or devices may also be used for trimming the ends of the armored cable pieces.

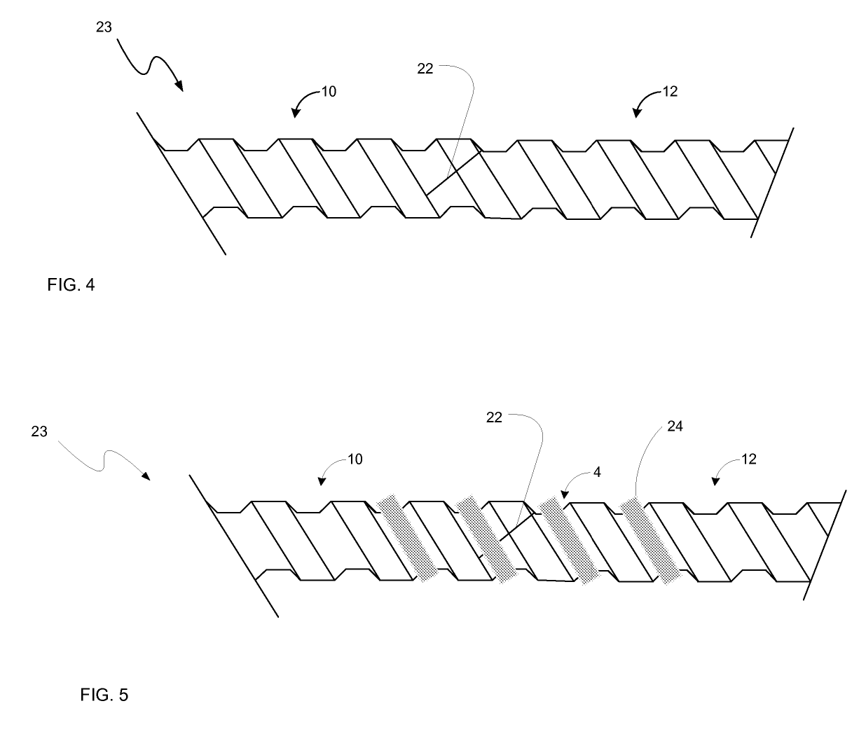

Turning to FIG. 3, after the ends 14, 16 of the pieces armored cable sheathing 10, 12 have been trimmed, the adjacent ends 14, 16 of the pieces of armored cable sheathing 10, 12 may be further trimmed to expose the complimentary interlocking profiles 19, 21 of the helically wound metal strip making up the respective pieces of armored cable sheathing 10, 12. In an embodiment consistent with the present disclosure, the ends 14, 16 of the pieces of armored cable sheathing 10, 12 may be trimmed to expose the complimentary interlocking profiles by cutting across the strip for at least one winding of the strip. For example, a cut may be made in the armored cable sheathing generally parallel to the axis of the respective pieces of armored cable sheathing 10, 12, such as indicated by the broken lines 18, 20 depicted in FIG. 2. While the illustrated cut lines 18, 20 are shown as being generally parallel to the axis of each piece of armored cable sheathing 10, 12, the respective cuts may additionally and/or alternatively be made at an angle relative to the axis of the respective pieces of armored cable. As mentioned, the cuts may encompass at least one width of the helically wound metallic strip. The cuts in the ends 14, 16 of the pieces of armored cable sheathing 10, 12 may be made using any suitable tool.

According to an alternative embodiment, the ends of the respective pieces of armored cable sheathing may be trimmed to expose the complimentary interlocking profiles of the helically wound metal strip, without first trimming the ends to a squared off shape. According to such an embodiment, the adjacent ends of the armored cable sheathing may be cut in a generally complimentary manner exposing the respective interlocking features of the adjacent pieces of armored cable sheathing without the preliminary trimming step. In still a further embodiment, it may only be necessary to trim one of the pieces of armored cable sheathing to expose the complimentary interlocking profiles to permit the pieces of armored cable sheathing to be threaded together. Furthermore, the nature of the broken end of armored cable sheathing and of the end of the new piece of armored cable sheathing may be such that no trimming is necessary to permit the pieces of armored cable sheathing to be threaded together.

Once the ends 14, 16 of the pieces of armored cable sheathing 10, 12 have been trimmed, if necessary, the pieces of armored cable sheathing 10, 12 may be coupled to one another, as shown in FIG. 4. According to one embodiment, the two pieces of armored cable sheathing 10, 12 may be threaded together. The pieces of armored cable sheathing 10, 12 may be threaded together by generally aligning the complimentary interlocking profiles of at the ends of the pieces of armored cable sheathing 10, 12 and twisting the pieces of armored cable sheathing 10, 12 relative to one another. As the pieces of armored cable sheathing 10, 12 are twisted relative to one another, the complimentary interlocking features at the respective ends 14, 16 may engage one another and thread, or screw, together. The threaded engagement of the two pieces of armored cable sheathing 10, 12 may draw the pieces 10, 12 together to provide a tight connection. The actual connection between the two pieces of armored cable sheathing 10, 12 may, however, vary according to the applied torque and the degree of compliment of the cuts exposing the respective complimentary interlocking features 19, 21. Accordingly, a tight connection between the two pieces of armored cable sheathing 10, 12 is not necessary within the scope of the present invention.

When the pieces of armored cable sheathing 10, 12 are threaded together to engage the complimentary interlocking features, the pieces of armored cable sheathing 10, 12 may form a generally continuous sheath 23. In an embodiment, the generally continuous sheath 23 including the threadably engaged pieces of armored cable sheathing 10, 12 may provide at least a portion of the tensile strength of a continuous run of armored cable. Additionally, the generally continuous sheath 23 may also provide a generally continuous covering over any electrical conductors that may be disposed therein.

Threading the respective pieces of armored cable sheathing 10, 12 together may include advancing at least one piece of armored cable sheathing over any conductors that may be disposed within the pieces of armored cable sheathing 10, 12. Again, in a manufacturing environment in which a first piece of armored cable sheathing is being extended, e.g. after a breakage of the metallic strip, advancing at least one of the pieces of armored cable sheathing over the conductors may be resisted by frictional interaction between the armored cable sheathing and the conductor(s) and/or may be resisted by the stiffness of the conductor(s) within the armored cable sheathing. Advancing a piece of armored cable sheathing over conductors disposed with the armored cable sheathing may be facilitated by joining and/or splicing the pieces of armored cable together while the second piece of armored cable sheathing is relatively short. When the second piece of armored cable sheathing is relatively short there may be a smaller length of material interacting with the conductors disposed within the second piece, thereby reducing resistance experienced by the armored cable sheathing sliding over the conductors.

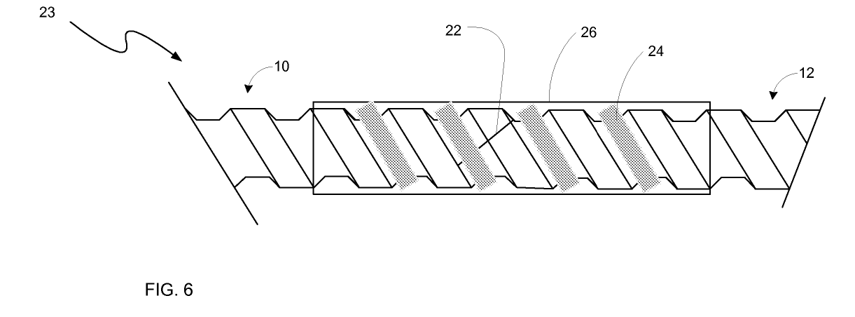

Turning to FIG. 5, according to one embodiment, after the pieces of armored cable sheathing 10, 12 have been threaded together to provide a generally continuous sheath 23, an electrically conductive member 24 may be provided to improve and/or ensure the electrical continuity of the sheath 23. The electrically conductive member 24 may be electrically coupled to each of the pieces of armored cable sheathing 10, 12 and may bridge and/or extend across the joint 22. Consistent with the illustrated embodiment, the electrically conductive member 24 may be helically wrapped around the pieces of armored cable sheathing 10, 12. For example, the electrically conductive member 24 may be at least partially disposed in a portion of the helical groove 4 of the sheath 23. In addition to, and/or as an alternative to, providing the electrically conductive member disposed in the helical groove of the sheath, an electrically conductive member may be provided generally extending along the length of the sheath and bridging the joint between the pieces of armored cable sheathing. Various other arrangements and/or orientations may also suitably be employed. According to an alternative embodiment, a conductive sleeve may be disposed over the sheath at least partially spanning the two pieces of armored cable sheathing. According to such an embodiment, the conductive sleeve may be crimped around the sheath to improve contact, and/or otherwise electrically and mechanically coupled to the sheath.

Various electrically conductive materials may be used to improve and/or ensure the electrical continuity of the sheath 23. According to various embodiments, the electrically conductive member 24 maybe a metallic strip, a length of wire, or other suitable electrically conductive material. In order to achieve a reliable electrical coupling between the electrically conductive member and the respective pieces of armored cable, it may be desirable to clean the sheath and/or to remove surface oxidation from the exterior of the pieces of armored cable 10, 12. The sheath may be cleaned using any variety of suitable solvents, cleaning agents, etc. Additionally, the sheath may also be cleaned to promote electrical coupling by mechanically abrading at least a portion of the sheath.

After the pieces of armored cable sheathing 10, 12 have been threaded together to provide a generally continuous sheath 23 and the pieces have been electrically coupled to make the sheath generally electrically continuous, a protective cover may be applied over the joint 22 and/or over the conductive member 24. According to one aspect, the protective cover 26 may ensure that the mechanical coupling provided by the threaded engagement of the respective pieces of armored cable sheathing 10, 12 is maintained. In an embodiment consistent with this aspect, the protective cover 26 may resist twisting of the pieces of armored cable sheathing 10, 12 relative to one another. Accordingly, the protective cover 26 may prevent and/or reduce the occurrence of the pieces of armored cable 10, 12 separating from one another. According to another aspect, the protective cover 26 may overlie at least a portion of the conductive member 24. The protective cover 26 may help maintain the conductive member 24 in physical contact with the sheath 23, thereby promoting electrical coupling between the conductive member 24 and the pieces of armored cable sheathing 10, 12. Additionally, the protective cover 26 may reduce the occurrence of physical damage to the conductive member 24 and/or to the pieces of armored cable 10, 12 in the region of the joint 22.

According to one embodiment, the protective cover 26 may be a heat-shrink tubing material. The heat-shrink tubing may be placed over one of the pieces of armored cable sheathing 10, 12 prior to coupling the pieces of armored cable sheathing 10, 12 to one another. After the pieces of armored cable sheathing 10, 12 have been threaded together and the conductive member 24 has been electrically coupled to the pieces of armored cable sheathing 10, 12, the heat-shrink tubing may be positioned to be disposed at least partially over the joint 22, as shown in FIG. 6. The heat-shrink tubing may then be heated causing the heat-shrink tubing to reduce diameter and/or conform to the generally continuous sheath 23.

According to one aspect, the heat-shrink tubing may include an adhesive on the inside thereof. In such an embodiment, the adhesive may further resist rotation of the pieces of armored cable sheathing 10, 12 relative to the protective cover 26 and, thereby, relative to one another. As such, the protective covering may further prevent unscrewing of the joint 22. Suitable adhesives may include both thermoplastic and/or thermoset adhesives, as well as pressure sensitive adhesives. An example of a suitable heat-shrink tubing including an adhesive on the inside of the tubing is RHW tubing available from Tyco Electronics. It may be desirable to clean the surface of the pieces of armored cable sheathing 10, 12 and/or the conductive member 24 to facilitate adhesion of the tubing. Cleaning may include chemical cleaning and/or mechanically abrading the surface of the pieces of armored cable sheathing 10, 12 and/or the conductive member 24 prior to applying the heat-shrink tubing.

According to an alternative embodiment, rather than heat-shrink tubing, a protective wrap or tape may be applied to the sheath at least partially covering the joint and/or the conductive member. In one embodiment, a protective tape may include a pressure sensitive adhesive. According to additional and/or alternative embodiments, the protective wrap or tape may include a thermoplastic and/or thermoset adhesive, which may set to provide a bond between the wrap or tape and the sheath and/or conductive member. As when using a heat-shrink tubing, the outer surfaces of the pieces of armored cable sheathing and/or of the conductive member may be cleaned prior to applying the protective wrap or tape. As discussed above, cleaning the pieces of armored cable sheathing and/or conductive member may facilitate proper adhesion of the protective wrap or tape.

Armored cable may often be color coded to indicate the variety of wiring contained within the sheath. According to one aspect, the protective covering may include color coding. The color coding of the protective covering may correspond to the color coding of the armored cable. As such, the generally continuous sheath may include a generally continuous color coding.

Consistent with the foregoing disclosure, an electrically conductive member may be provided as a separate component disposed in electrical contact with the sheath and covered by the protective cover. According to various additional and/or alternative embodiments, electrical continuity of the sheath may be provided using a protective cover including electrically conductive features. For example, the protective cover may include an electrically conductive adhesive on at least a portion of the interior of the protective cover. Accordingly, when the protective cover is adhered to the sheath, the electrically conductive adhesive may not only bond the pieces of armored cable sheathing to the protective cover, but may also electrically couple the pieces of armored cable sheathing. In a related embodiment, one or more electrically conductive pathways may be provided on the interior of the protective cover. For example, heat-shrink tubing may be provided having one or more electrically conductive strips extending from one end of the tube to the other end of the tube. When the heat-shrink tubing is heated and reduced in diameter to conform to the sheath, the electrically conductive strip may contact the sheath. Contact between the electrically conductive strip and the sheath may improve and/or ensure electrical continuity across the joint between the pieces of armored cable sheathing.

As discussed previously, an electrically conductive sleeve may be disposed over the sheath. The sleeve may be crimped, or otherwise electrically and mechanically coupled to the sheath. According to one such embodiment, the electrically conductive sleeve may not only improve and/or ensure electrical continuity across the joint between the pieces of armored cable sheathing, but may also serve as a protective cover and/or may resist separation of the pieces of armored cable sheathing, as from untwisting.

Electrical continuity of the sheath may also be provided by securely coupling the pieces of armored cable sheathing to one another. For example, when the pieces of armored cable sheathing are threadably coupled together there may be sufficient physical contact between the respective metallic strips to electrically couple the pieces of armored cable sheathing. Further providing a protective layer, or other means for resisting separating of the pieces of armored cable sheathing, may ensure that the pieces of armored cable sheathing remain physically and electrically coupled to one another without the need for additional features. In other embodiments, electrical continuity of the sheathing may not be a critical aspect. Consistent with such an embodiment, it may not be necessary to undertake measures to improve and/or ensure electrical continuity of the sheath.

Consistent with one aspect of the present disclosure, a method is provided for joining and/or splicing two, or more, pieces of armored cable sheathing to provide a generally continuous sheath. Consistent with the disclosure, adjacent ends of two pieces of armored cable sheathing may be trimmed to exposed complimentary interlocking features. The pieces of armored cable sheathing may be threadably coupled to one another by engaging the complimentary interlocking features and twisting, or rotating, the pieces of armored cable sheathing relative to one another. The threadably coupled pieces of armored cable sheathing may be mechanically coupled to prevent unscrewing and/or separation of the two pieces of armored cable sheathing. The pieces of armored cable sheathing may be mechanically coupled by a protective layer, such as a heat-shrink tubing, tape, crimpable sleeve, etc. According to various embodiments, electrical continuity of the joined pieces of armored cable sheathing may be improved and/or ensured by providing an electrically conductive member extending across the joint and electrically coupled to each of the pieces of armored cable sheathing.

The present invention is susceptible to variation and modification from the embodiments described herein. Additionally, the features and aspects of the various described embodiments are susceptible to combination with one another. Accordingly, the described embodiments should be understood to be exemplary embodiments consistent with the present invention and should not be construed as limiting.

What is claimed is:

1. A method of joining helically wound armored cable sheathing comprising:
trimming adjacent ends of a first and second piece of armored cable sheathing to provide complimentary interlocking features;
coupling said first and second pieces of armored cable sheathing, comprising engaging said complimentary interlocking features and twisting said first and second piece of armored cable sheathing relative to one another; and
mechanically coupling said first and second pieces of armored cable sheathing to resist untwisting of said first and second pieces of armored cable sheathing relative to one another.

2. The method according to claim 1, wherein trimming said adjacent ends to provide complimentary interlocking features comprises trimming said adjacent ends generally perpendicular to respective longitudinal axes of said first and second pieces of armored cable sheathing.

3. The method according to claim 1, wherein trimming said adjacent ends to provide complimentary interlocking features comprises cutting across at least one helical winding of at least one of said first and second pieces of armored cable sheathing.

4. The method according to claim 3, wherein cutting across at least one helical winding comprises cutting said helical winding generally parallel to a longitudinal axis of said at least one of said first and second pieces of armored cable sheathing.

5. The method according to claim 1, wherein coupling said first and second pieces of armored cable sheathing comprises advancing at least one of said pieces over a conductor disposed at least partially within said at least one of said pieces of armored cable sheathing.

6. The method according to claim 1, further comprising electrically coupling said first and second pieces of armored cable sheathing.

7. The method according to claim 6, wherein electrically coupling said first and second pieces of armored cable sheathing comprises electrically coupling an electrically conductive member to said first and second pieces of armored cable sheathing.

8. The method according to claim 7, wherein electrically coupling said electrically conductive member to said first and second pieces of armored cable sheathing comprises helically winding said electrically conductive member around said first and second pieces of armored cable sheathing.

9. The method of claim 1, wherein mechanically coupling said first and second pieces of armored cable sheathing comprises applying heat shrink tubing around at least a portion of said first and second pieces of armored cable sheathing.

10. The method of claim 1, wherein mechanically coupling said first and second pieces of armored cable sheathing comprises wrapping an adhesive tape around at least a portion of said first and second pieces of armored cable sheathing.

11. A method of joining helically wound armored cable sheathing comprising:
trimming adjacent ends of a first and second piece of armored cable sheathing to provide complimentary interlocking features;
engaging said complimentary interlocking features with one another;
twisting said engaged first and second pieces of armored cable sheathing relative to one another;
electrically coupling said first and second pieces of armored cable sheathing; and
mechanically coupling said first and second pieces of armored cable sheathing to resist untwisting relative to one another.

12. The method according to claim 11, wherein trimming adjacent ends of said first and second pieces of armored cable sheathing comprises cutting across at least one helical winding of at least one of the pieces of armored cable sheathing.

13. The method according to claim 11, wherein mechanically coupling said first and second pieces of armored cable sheathing comprises applying heat shrink tubing over at least a portion of said first and second pieces of armored cable sheathing and at least a portion of an electrically conductive member electrically coupled to said first and second piece of armored cable sheathing.

14. The method according to claim 11, wherein electrically coupling said first and second pieces of armored cable sheathing comprises disposing an electrically conductive member in electrical contact with said first and second pieces of armored cable sheathing.

15. The method according to claim 14, wherein disposing said electrically conductive member in electrical contact with said first and second pieces of armored cable sheathing comprises helically wrapping an electrically conductive wire around at least a portion of said first and second pieces of armored cable sheathing.
